(19) United States
(12) Patent Application Publication
(10) Pub. No.: US 2005/0218226 A1
(43) Pub. Date: Oct. 6, 2005

(54) Data storage system with card reader

(76) Inventor: Ching-Chung Wang, Anding Shiang (TW)

Correspondence Address: HOFFMAN WARNICK & D'ALESSANDRO, LLC, 75 STATE STREET, 14TH FL, ALBANY, NY, 12207, US

(21) Appl. No.: 10/970,505

(22) Filed: Oct. 21, 2004

(30) Foreign Application Priority Data
Mar. 30, 2004 (TW) 093108628

(51) Int. Cl. G06K 7/00

(52) U.S. Cl. 235/440

(57) ABSTRACT

The invention relates to a data storage system. The data storage system comprises a memory device, a card reading/writing device, and an optical storage device. The memory device comprises a memory and a memory controller and connects with the memory controller. The card reading/writing device connects to the memory device and comprises a direct memory access controlling circuit, so that a first data is communicated between the card reading/writing device and the memory device via a direct memory access approach. The optical storage device connects to the memory device, so that a second data is directly communicated between the optical storage device and the memory device, wherein the first data or the second data is directly communicated between the card reading/writing device and the optical storage device via the memory device.

### BACKGROUND OF INVENTION

1. Field of the Invention

This present invention relates to a data storage system; more particularly, the present invention relates to a data storage system comprising a plurality of data storage devices, wherein each data storage device directly communicates the stored data with each other without going via the central processing unit.

2. Description of the Prior Art

With the development of science and technology, digitized data have been changed from character form to multimedia form; in the meantime, the storing capacity and the storing speed of the storing mediums have become more important. Memory cards made by flash memory have the advantages of having large storing capacity and being easy to carry, and it is one of the common storing mediums. Beside the memory cards, optical storing mediums, such as CD, CD-R, CD-RW, and even DVD, are also common storing mediums. Some devices can even adapt to multiple storing mediums, so as to satisfy the user's need. When a computer system has more than one storing medium, the user can backup the data from a specific storing medium to another storing medium.

According to the portable data backup device, disclosed in the U.S. Pat. No. 6,588,662, the portable data backup device comprises a flash memory card reader, a multimedia decoder, a controlling unit, and a backup unit. The portable data backup device connects the controlling unit and the multimedia decoder via an RS232 interface, and it connects the backup unit and the controlling unit via an IDE interface. The portable data backup device reads the data from the memory card via the flash memory card reader, and beside being transmitted to the multimedia decoder for playing, the data can also be transmitted to the controlling unit and then transmitted from the controlling unit to the backup unit for storing.

According to the DVD player with card reader, disclosed in the U.S. Pat. No. 6,598,100, the DVD player with card reader comprises a card reader, a CD-ROM drive, an adapting interface, and an AV processor. The card reader and the CD-ROM drive respectively connect to the adapting interface and transmit the stored data to the AV processor via the adapting interface. In this prior art, the adapting interface comprises a build-in controller for receiving the data from the card reader and the CD-ROM drive, for transforming the received data to the data with ATA format, and for transmitting that to the AV processor. The central processing unit of the AV processor further processes the received data and further transmits the data read from the CD-ROM drive to the card reader. Then, the data can be backed-up in the memory card.

According to the CD-ROM drive with multi-card reader, disclosed in Taiwan Patent Publication No. 091217541, the CD-ROM drive with multi-card reader comprises a CD reading/writing driver, a multi-card reader controller, a micro controller, and a data encoding/decoding device. The CD reading/writing driver and the multi-card reader controller are connected to the micro controller and the data encoding/decoding device. The CD reading/writing driver and the multi-card reader controller respectively read the data from a CD and a memory card. The CD reading/writing driver and the multi-card reader controller of the CD-ROM drive with multi-card reader communicate the data via the micro controller and the buffer memory.

According to the above-mentioned prior arts, data storage devices, such as the CD-ROM drive or the card reader, can transmit the stored data to the controller or the processor under the command of the controller. The controller or the processor also can transmit the data to the CD-ROM drive or the card reader for storage. However, when the data are transmitted from a specific data storage device to another data storage device for back-up, the controller or processor must stop other work in progress during the data transmission, so that the controller or processor can receive the data transmitted from a specific data storage device and then transmit the data to another data storage device. Thus, when performing the data transmission between the data storage devices, the conventional method increases the load of the controller or processor and lowers the efficiency.

The present invention provides a data storage system and a data processing method to improve the efficiency of the processor or the controller when performing the data transmission between the data storage devices.

### SUMMARY OF INVENTION

The present invention relates to a data storage system; more particularly, the present invention relates to a data storage system comprising a plurality of data storage devices, wherein each data storage device directly communicates the stored data with each other without going through the central processing unit.

The invention is a data storage system, which comprises a memory device, a card reading/writing device, and an optical storage device. The memory device comprises a memory and a memory controller, and it connects with the memory controller. The card reading/writing device connects to the memory device, and it comprises a direct memory access controlling circuit, so that a first data is directly communicated between the card reading/writing device and the memory device. The optical storage device connects to the memory device, so that a second data is directly communicated between the optical storage device and the memory device. By this method, the first data or the second data is directly communicated between the card reading/writing device and the optical storage device via the memory device.

The data storage system of the present invention is able to directly read or write the data among the plurality of data storage devices without going through the central processing unit, so as to reduce the load of the central processing unit and increase the processing efficiency.

### BRIEF DESCRIPTION OF THE APPENDED DRAWINGS

FIG. 1 is a block diagram of the data storage system according to the present invention.

FIG. 2 is a block diagram of the data storage system according to another embodiment of the present invention.

FIG. 3 is a flow chart of the data processing method according to the present invention.

FIG. 4 is a flow chart of the data processing method according to another embodiment of the present invention.

### DETAILED DESCRIPTION OF INVENTION

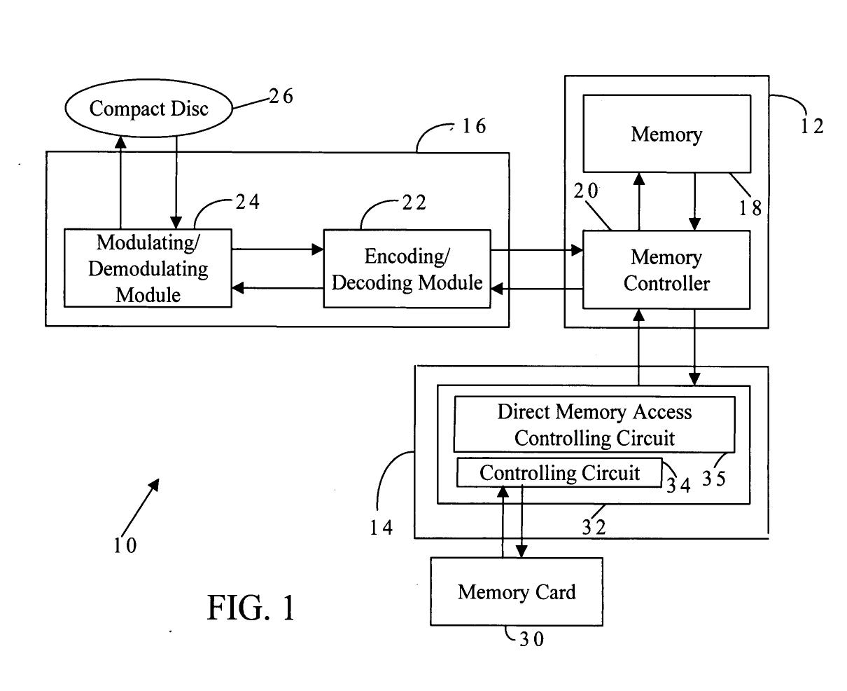

Referring to FIG. 1, FIG. 1 is a block diagram of the data storage system 10 according to the present invention. The data storage system 10 comprises a memory device 12, a card reading/writing device 14, and an optical storage device 16. The card reading/writing device 14 and the optical storage device 16 respectively connect with the memory device 12, wherein the card reading/writing device 14 directly communicates a first data with the memory device 12, and the optical storage device 16 directly communicates a second data with the memory device 12.

The memory device 12 comprises a memory 18 and a memory controller 20. The memory can be a DRAM, SRAM, or other semiconductor memory. The memory controller 20 connects to the memory 18. The memory controller 20 is used for controlling the memory 18. The memory 18 is used for receiving and storing the data transmitted from the memory controller 20 to be used later. When the memory device 12 communicates the first data with the card reading/writing device 14, the memory controller 20 is used for controlling the transmission and reception of the first data, so that the first data can be directly transmitted between the memory device 12 and the card reading/writing device 14. When the optical storage device 16 communicates the second data with the memory device 12, the memory controller 20 writes or reads the second data from the memory 18, so that the second data can be directly transmitted between the memory device 12 and the optical storage device 16 without passing through other devices.

In this embodiment, the card reading/writing device 14 at least comprises a card controller 32; the card controller 32 connects to the memory card 30 for reading the first data stored in the memory card 30. The memory card 30 can be a memory stick card, a compact flash card, a multi media card, a secure digital card, or a smart media card. The card controller 32 connects between the memory card 30 and the memory controller 20 of the memory device 12 for controlling the reading/writing function of the memory card 30 and for communicating the first data with the memory device 12. The card controller 32 comprises a controlling circuit 34 and a direct memory access controlling (DMA) circuit 35. When the data storage system 10 reads the first data stored in one memory card 30, the controlling circuit 34 of the card controller 32 reads the first data stored in the memory card 30 and transmits the first data to the memory controller 20 of the memory device 12 via direct memory access under the control of the direct memory access controlling circuit 35. Then, the memory controller 20 stores the first data into the memory 18. When the data storage system 10 writes the first data in the memory card 30, the data storage system 10 transmits the first data stored in the memory 18 from the memory controller 20 to the card controller 32 via direct memory access. Then, the card controller 32 transmits and stores the received first data in the memory card 30.

The optical storage device 16 comprises an encoding/decoding module 22 and a modulating/demodulating module 24. The memory controller 20 connects with the encoding/decoding module 22, and the encoding/decoding module 22 further connects with the modulating/demodulating module 24. In this embodiment, the modulating/demodulating module 24 is used for modulating or demodulating the second data directly communicated between the optical storage device 16 and the memory device 12; for example, the modulation/demodulation is a eight to fourteen modulation/demodulation (EFM) for transforming a 14-code data to a 8-code data or a 8-code data to a 14-code data through a predetermined transforming method. The encoding/decoding device 22 is used for encoding or decoding the second data. When the data storage system 10 reads the second data from the optical storage device 16, the optical storage device 16 reads and transmits the second data from the compact disc 26 to the modulating/demodulating module 24 first; the modulating/demodulating module 24 demodulates the second data and then transmits the second data to the encoding/decoding module 22. Then, the encoding/decoding module 22 decodes the second data and transmits to the memory device 12. On the other hand, when the data storage system 10 writes the second data into the optical storage device 16, the memory device 12 transmits the second data to the encoding/decoding module 22 for encoding, and then the encoding/decoding module 22 transmits the second data to the modulating/demodulating module 24; the modulating/demodulating module 24 further modulates the second data.

In one embodiment, the optical storage device 16 can be a readable/writeable optical storage device, such as CD-R(W), DVD-RAM, DVD-R(W), and DVD+R(W) drive, and the compact disc 26 is a readable/writeable compact disc. When the data storage system 10 writes the second data to a readable/writeable compact disc 26 connecting with the optical storage device 16, the data storage system 10 first transmits the second data stored in the memory 18 to the encoding/decoding device 22 by the memory controller 20 for encoding. Then, the encoding/decoding module 22 transmits the second data to the modulating/demodulating module 24 for modulating the second data. Finally, the data storage system 10 stores the modulated second data into the readable/writeable compact disc 26. On the other hand, when the data storage system 10 reads the second data from the readable/writeable compact disc 26, the data storage system 10 first transmits the second data to the modulating/demodulating module 24 of the optical storage device 16; then, the modulating/demodulating module 24 demodulates the second data and transmits to the encoding/decoding module 22. Then, the encoding/decoding module 22 decodes the second data and transmits to the memory device 12.

According to the above description, because the card reading/writing device 14 communicates the first data with the memory device 12 via direct memory access, and the optical storage device 16 directly communicates the second data with the memory device 12, so the card reading/writing device 14 and the optical storage device 16 access data in the memory device 12 at the same time; furthermore, the card reading/writing device 14 and the optical storage device 16 can directly communicate the first data or the second data by the memory device 12.

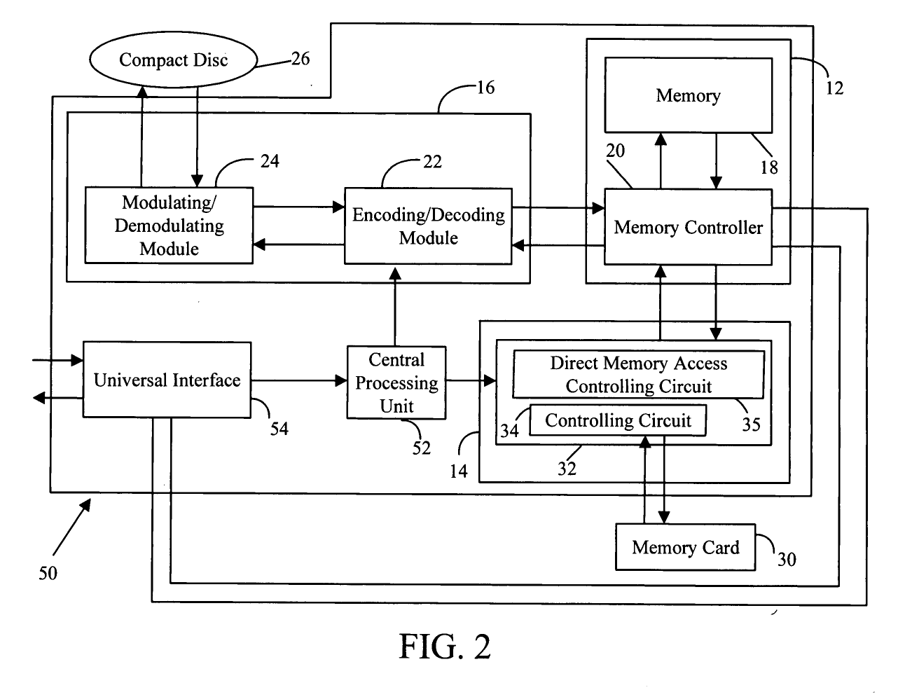

FIG. 2 is a block diagram of the data storage system according to another embodiment of the present invention. Here, besides the components shown in FIG. 1, the data storage system 50 further comprises a central processing unit (CPU) 52 and a universal interface 54. The universal interface 54 connects to the central processing unit 52 and the memory device 12; the central processing unit 52 further connects to the card reading/writing device 14 and the optical storage device 16. The memory device 12 comprises a memory 18 and a memory controller 20; the memory controller 20 connects with the memory 18. The memory controller 20 is used for controlling the memory 18. The memory 18 is used for receiving and storing the data transmitted from the memory controller 20 to be used later. When the card reading/writing device 14 communicates the first data with the memory device 12 by the direct memory access controlling circuit 35 of the card reading/writing device 14, the first data can be transmitted between the memory device 12 and the card reading/writing device 14 without passing through the central processing unit 52. Because the card reading/writing device 14 can communicate the first data with the memory device 12 via direct memory access, and the optical storage device 16 can communicate the second data with the memory device 12, by the assistance of the memory device 12, the card reading/writing device 14 and the optical storage device 16 can directly communicate the first data or the second data via direct memory access without passing through the central processing unit 52.

In this embodiment, the data storage system 50 not only has all the functions of the data storage system 10 but also connects to a third device (not shown) via the universal interface 54. The third device communicates the third data with the card reading/writing device 14 through the universal interface 54 and the memory device 12 via direct memory access, or directly communicates a third data with the optical storage device 16 without passing through the central processing unit 52.

For example, when the data storage system 50 transmits the third data from the card reading/writing device 14 to the universal interface 54 and further transmits to the third device, the data storage system 50 first transmits the third data stored in the memory card 30 to the memory 18 of the memory device 12 via direct memory access; then, the universal interface 54 reads the third data from the memory 18 of the memory device 12 to the third device. When the data storage system 50 transmits the third data from the optical storage device 16 to the universal interface 54 and further transmits to the third device, the data storage system 50 first transmits the stored third data to the memory 18 of the memory device 12; then, the universal interface 54 reads the third data from the memory 18 of the memory device 12 to the third device.

In this embodiment, the universal interface 54 comprises a direct memory access controlling circuit, so that the third device and the memory device 12 can read or write data via direct memory access. In this embodiment, when the data storage system 50 transmits the third data from the card reading/writing device 14 to the universal interface 54 and further transmits to the third device, or when the data storage system 50 transmits the third data from the third device to the universal interface 54 and further transmits to the card reading/writing device, the universal interface 54 can make the third device communicate data with the memory device 12 via direct memory access without passing through the central processing unit 52. On the other hand, when the data storage system 50 transmits the third data from the optical storage device 16 to the universal interface 54 and further transmits to the third device, or when the data storage system 50 transmits the third data from the third device to the universal interface 54 and further transmits to the optical storage device 16, the third device can also communicate data with the memory device 12 via direct memory access and then transmit the data to the optical storage device 16 via the memory device 12 without passing through the central processing unit 52. Therefore, by the direct memory access controlling circuit of the universal interface 54, the third device can communicate data with the card reading/writing device 14 or the optical storage device 16 by the assistance of the memory device 12 via direct memory access.

By the installed direct memory access controlling circuit, the card reading/writing device 14 and the third device can respectively communicate data with the memory device 12 via direct memory access. The optical storage device 16 directly connects with the memory device 12; therefore, the optical storage device 16 directly communicates data with the memory device 12. Through the memory device 12, the card reading/writing device 14, the optical storage device 16, and the third device can communicate data without passing through the central processing unit 52. Therefore, the present invention is able to decrease the work load of the central processing unit 52, increase the efficiency, and make the card reading/writing device 14, the optical storage device 16, and the third device co-use the memory device 12 as the memory for data transmission, so as to adjust the transmission speed and decrease the cost of hardware.

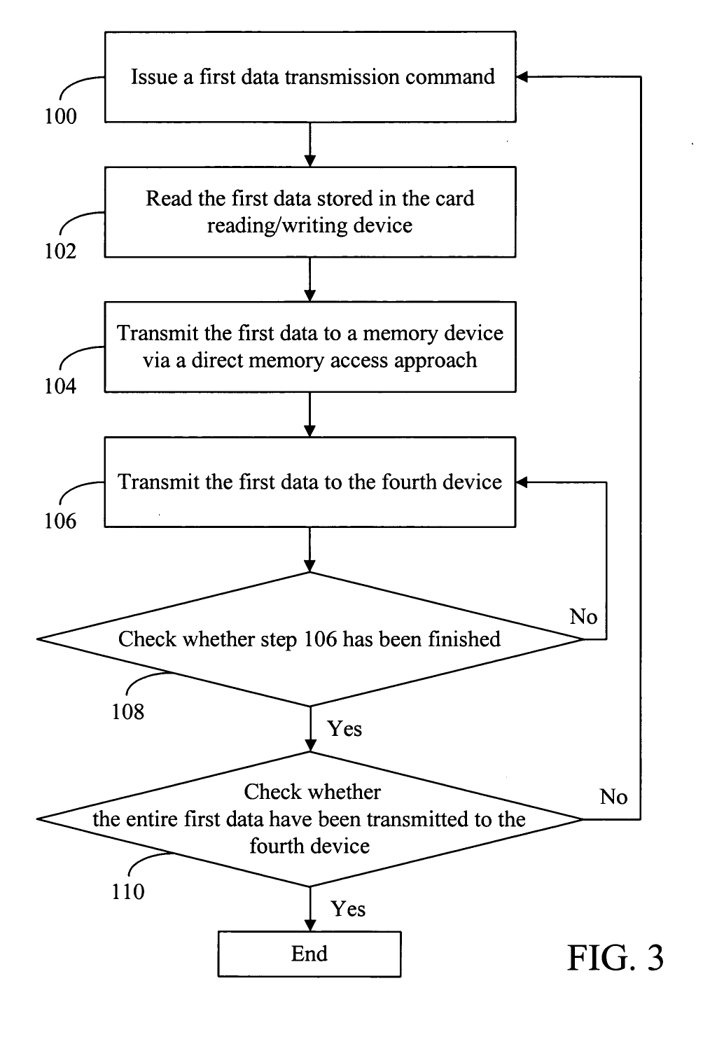

Referring to FIG. 3, FIG. 3 is a flow chart of the data processing method according to the present invention. The data processing method is applied in the above-mentioned data storage system 50 for outputting the first data from the card reading/writing device 14 to the fourth device. The data processing method comprises the following steps:
Step 100: Issue a first data transmission command to the card reading/writing device 14;
Step 102: Read parts of the first data stored in the card reading/writing device 14;
Step 104: Transmit the parts of the first data to the memory controller 20 of the memory device 12 via a direct memory access approach, and further transmit part of the first data to the memory 18 by the memory controller 20 to be used later;
Step 106: Transmit part of the first data from the memory controller 20 of the memory device 12 to the fourth device;
Step 108: Check whether step 106 has been finished; if the answer is negative, then continue performing step 106, and if the answer is positive, then perform step 10; and
Step 110: Check whether the entire first data has been transmitted to the fourth device; if the answer is negative, then perform step 100, and if the answer is positive, then end the data processing method.

By the step 100 to the step 110, the card reading/writing device 14 can directly transmit the first data to the fourth device via the memory device 12, wherein the fourth device can be the optical storage device 16. The card reading/writing device 14 can transmit data through the memory device 12 to the optical storage device 16 via direct memory access; users can also backup the data originally stored in the card reading/writing device 14 to the readable/writable compact disc without passing through the central processing unit.

Besides, in one embodiment of the present invention, the fourth device can also comprise a universal interface and a memory storage device or a computer system, which connects to the universal interface. The card reading/writing device 14 can directly transmit the first data to the universal interface via the memory device 12 and further transmit the first data to the memory storage device or the connected computer system. For example, the memory storage device can be a hard disk drive or other storing medium, and the computer system can be a common personal computer or a user-defined hardware. The universal interface comprises a direct memory access controlling circuit, so that the fourth device can communicate data with the memory device 12 via direct memory access.

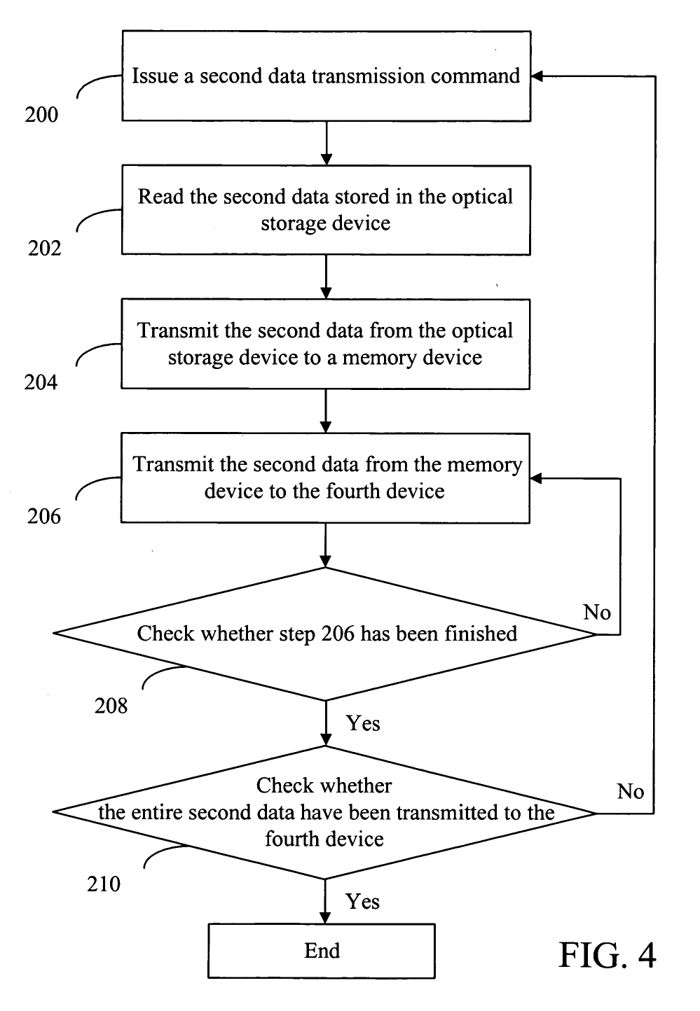

Referring to FIG. 4, FIG. 4 is a flow chart of the data processing method according to another embodiment of the present invention. The data processing method is applied in the above-mentioned data storage system 50 for outputting the second data from the optical storage device 16 to the fourth device. The data processing method comprises the following steps:
Step 200: Issue a second data transmission command to the optical storage device 16;
Step 202: Read part of the second data stored in the optical storage device 16;
Step 204: After modulating by the modulating/demodulating module 24 and decoding by the encoding/decoding module 22, transmit part of the second data from the optical storage device 16 to a memory device and further transmit the part of the second data to the memory 18 by the memory controller 20 to be used later;
Step 206: Transmit the part of the second data from the memory controller 20 of the memory device 12 to the fourth device;
Step 208: Check whether step 206 has been finished; if the answer is negative, then perform step 206, and if the answer is positive, then perform step 210; and
Step 210: Check whether the entire second data has been transmitted to the fourth device; if the answer is negative, then perform step 200, and if the answer is positive, then end the data processing method.

By the step 200 to step 210, the optical storage device 16 can directly transmit the second data to the fourth device via the memory device 12, wherein the fourth device can be the card reading/writing device 14. The optical storage device 16 can transmit data through the memory device 12 to the card reading/writing device 14; users can also backup the data originally stored in the optical storage device 16 to the card reading/writing device 14 without passing through the central processing unit.

Besides, according to the above description, the fourth device can also comprise a universal interface and a memory storage device or a computer system, which connects to the universal interface. The optical storage device 16 can directly transmit the second data to the universal interface via the memory device 12 and further transmit the second data to the memory storage device or the computer system. The using method of the fourth device is the same as the above descriptions and will not be described here again.

According to the above-mentioned data processing method, the memory card used by the card reading/writing device 14 can be a memory stick card, a compact flash card, a multi media card, a secure digital card, or a smart media card.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A data storage system, comprising:
a memory device, comprising a memory and a memory controller, the memory connecting with the memory controller;
a card reading/writing device, the card reading/writing device connecting to the memory device, the card reading/writing device comprising a direct memory access controlling circuit, so that a first data is communicated between the card reading/writing device and the memory device via a direct memory access approach; and
an optical storage device, the optical storage device connecting to the memory device, so that a second data is directly communicated between the optical storage device and the memory device;
wherein the first data or the second data is directly communicated between the card reading/writing device and the optical storage device via the memory device.

2. The data storage system of claim 1, wherein the card reading/writing device comprises a card controller, and the card controller comprises the direct memory access controlling circuit and connects between a memory card and the memory controller, so that the first data is communicated between the memory card and the memory device via direct memory access.

3. The data storage system of claim 2, wherein the memory card is a memory stick card, a compact flash card, a multi media card, a secure digital card, or a smart media card.

4. The data storage system of claim 1, wherein the optical storage device comprises:
an encoding/decoding module connecting with the memory controller for encoding or decoding the second data; and
a modulating/demodulating module connecting with the encoding/decoding module for modulating or demodulating the second data.

5. The data storage system of claim 4, wherein the optical storage device is a readable/writeable optical storage device.

6. A data storage system, comprising:
a central processing unit;
a universal interface, connecting to the central processing unit;
a memory device, comprising a memory and a memory controller, the memory connecting with the memory controller;
a card reading/writing device, the card reading/writing device connecting to the memory device, the card reading/writing device comprising a direct memory access controlling circuit so that a first data is communicated between the card reading/writing device and the memory device via a direct memory access approach; and
an optical storage device, the optical storage device connecting to the memory device and the central processing unit, so that a second data is directly communicated between the optical storage device and the memory device;
wherein the first data or the second data is directly communicated between the card reading/writing device and the optical storage device via the memory device.

7. The data storage system of claim 6, wherein the card reading/writing device comprises a card controller, and the card controller comprises the direct memory access controlling circuit and connects between a memory card and the memory controller, so that the first data is communicated between the memory card and the memory device.

8. The data storage system of claim 7, wherein the memory card is a memory stick card, a compact flash card, a multi media card, a secure digital card, or a smart media card.

9. The data storage system of claim 6, wherein the optical storage device comprises:
an encoding/decoding module connecting with the memory controller for encoding or decoding the second data; and
a modulating/demodulating module connecting with the encoding/decoding module for modulating or demodulating the second data.

10. The data storage system of claim 9, wherein the optical storage device is a readable/writeable optical storage device.

11. The data storage system of claim 6, wherein the universal interface further connects to a third device, and the universal interface comprises a direct memory access controlling circuit so that a third data is communicated between the third device and the memory device via direct memory access.

12. The data storage system of claim 11, wherein the third data is communicated between the third device and the optical storage device via the universal interface and the memory device.

13. The data storage system of claim 11, wherein the third data is communicated between the third device and the card reading/writing device via the universal interface and the memory device.

14. A data processing method for transmitting a first data from a card reading/writing device to a fourth device, the data processing method comprising the following steps:
(1) issuing a first data transmission command;
(2) reading parts of the first data stored in the card reading/writing device;
(3) transmitting part of the first data from the card reading/writing device to a memory device via a direct memory access approach;
(4) transmitting the part of the first data from the memory device to the fourth device;
(5) checking whether step (4) has been finished, if the answer is negative, then continuing performing step (4), and if the answer is positive, then performing step (6); and
(6) checking whether the entire first data has been transmitted to the fourth device, if the answer is negative, then performing step (2), and if the answer is positive, then ending the data processing method.

15. The data processing method of claim 14, wherein the fourth device comprises an optical storage device.

16. The data processing method of claim 15, wherein the optical storage device is a readable/writeable optical storage device.

17. The data processing method of claim 14, wherein the fourth device further comprises a universal interface and a third device connected to the universal interface, and the universal interface connects to the memory device, wherein the card reading/writing device directly transmits the first data to the fourth device via the memory device and the universal interface.

18. The data processing method of claim 17, wherein in step (4), part of the first data are transmitted from the memory device to the fourth device via direct memory access.

19. A data processing method for transmitting a second data from an optical storage device to a fourth device, the data processing method comprising:
(1) issuing a second data transmission command;
(2) reading parts of the second data stored in the optical storage device;
(3) transmitting part of the second data from the optical storage device to a memory device;
(4) transmitting the part of the second data from the memory device to the fourth device;
(5) checking whether step (4) has been finished, if the answer is negative, then performing step (4), and if the answer is positive, then performing step (6); and
(6) checking whether the entire second data has been transmitted to the fourth device, if the answer is negative, then performing step (2), and if the answer is positive, then ending the data processing method.

20. The data processing method of claim 19, wherein the fourth device comprises a card reading/writing device, the card reading/writing device comprises a card controller and a memory card, the card controller connects between the memory card and the memory device, the card controller comprises a direct memory access controlling circuit, so that the fourth device communicates the parts of the second data with the memory device via direct memory access.

21. The data processing method of claim 20, wherein the memory card is a memory stick card, a compact flash card, a multi media card, a secure digital card, or a smart media card.

22. The data processing method of claim 19, wherein the fourth device further comprises a universal interface and a third device connected to the universal interface, and the universal interface connects to the memory device, wherein the optical storage device directly transmits the second data to the fourth device via the memory device and the universal interface.
